(19) United States
(12) Patent Application Publication
(10) Pub. No.: US 2017/0140391 A1
(43) Pub. Date: May 18, 2017

(54) DETECTION OF INTERNAL FRAUDS

(71) Applicant: International Business Machines Corporation, Armonk, NY (US)

(72) Inventors: Mike A. Marin, Laguna Hills, CA (US); Vivek K. Paramashivapa, BANGALORE (IN); Balunaini Prasad, BANGALORE (IN)

(21) Appl. No.: 14/938,901

(22) Filed: Nov. 12, 2015

(51) Int. Cl. G06Q 30/00

(52) U.S. Cl. CPC G06Q 30/0185

(57) ABSTRACT

Embodiments of the present invention provide systems and methods for detecting internal fraud. The systems and methods for detecting internal fraud involve: receiving information pertaining to a case; receiving information pertaining to a case worker assigned to a case; compiling and configuring the sensitivity of the tasks needed to complete a case; determining a path by which a case is completed; and comparing a path of a first case with the path of a second case. A threshold value is configured to determine the level of deviation between the path of the first case and the path of the second case. If a case is determined to have a level of deviation at or above a threshold value, then an alarm is triggered to indicate a potential fraud.

### BACKGROUND OF THE INVENTION

The present invention relates generally to the field of monitoring data and more specifically to the detection of internal frauds.

Case management systems are utilized by case workers in order to assemble, analyze, act on, and archive content for business solutions. When processing a case, case management systems offer the flexibility to case workers to appropriately choose and execute tasks (i.e., activities). The case workers have at their disposal a set of optional and ad-hoc discretionary tasks to execute, depending on the context of a case. Execution of these tasks moves a case towards completion.

Internal fraud is wrong doing done by employee(s) within an organization by processing cases either by: (i) by-passing a set of mandatory processes which should have been followed to complete a case; or (ii) by executing a process that should not have been executed to complete a case.

### SUMMARY

According to one embodiment of the present invention, a method for detecting internal fraud is provided with the method comprising the steps of: receiving, by one or more processors, case information to be processed; analyzing, by one or more processors, the case information to be processed; storing, by one or more processors, a set of resultant information from the case information to be processed within a knowledge base; comparing, by one or more processors, a threshold value associated with the first case to a threshold value associated with a second case from a repository, wherein the threshold value is a measure of deviation between an executed path of the first case and an executed path of the second case; determining, by one or more processors, whether the threshold value is above a preconfigured value; and responsive to determining the threshold value is above the predetermined value, triggering, by one or more processors, an alert of a potential fraud.

Another embodiment of the present invention provides a computer program product for detecting internal fraud, based on the method described above.

Another embodiment of the present invention provides a computer system for detecting internal fraud, based on the method described above.

### BRIEF DESCRIPTION OF THE DRAWINGS

FIG. 1 is a functional block diagram illustrating a data processing environment, in accordance with an embodiment of the present invention;

FIG. 2 is a flowchart depicting the operational steps performed by fraud module 110 in order to form a knowledge base for an internal fraud detecting system, in accordance with an embodiment of the present invention;

FIG. 3 is a functional block diagram illustrating a schema of a fraud module for storing relational tables, in accordance with an embodiment of the present invention;

FIG. 4 is an example of relational tables, in accordance with an embodiment of the present invention;

FIG. 5 is a flowchart depicting the operational steps of determining fraud via pathways by fraud module 110, in accordance with an embodiment of the present invention; and

FIG. 6 depicts a block diagram of internal and external components of a computing device, in accordance with an embodiment of the present invention.

### DETAILED DESCRIPTION

The inherent flexibility of a case management systems permits instances where a case worker may bypass a set of processes which need to be strictly followed. The misuse of case management systems can lead to internal fraud. Typical fraud detecting systems are geared towards detecting external frauds (e.g., the submission of fraudulent information by a customer). Internal fraud within the case management systems is plausible as the case management system provides an inherently high degree of flexibility to case workers. In such instances, organizations may have a need to identify and prevent internal frauds. Embodiments of the present invention describe methods and systems to identify internal frauds, and the case worker(s) involved in the internal fraud, in case management systems.

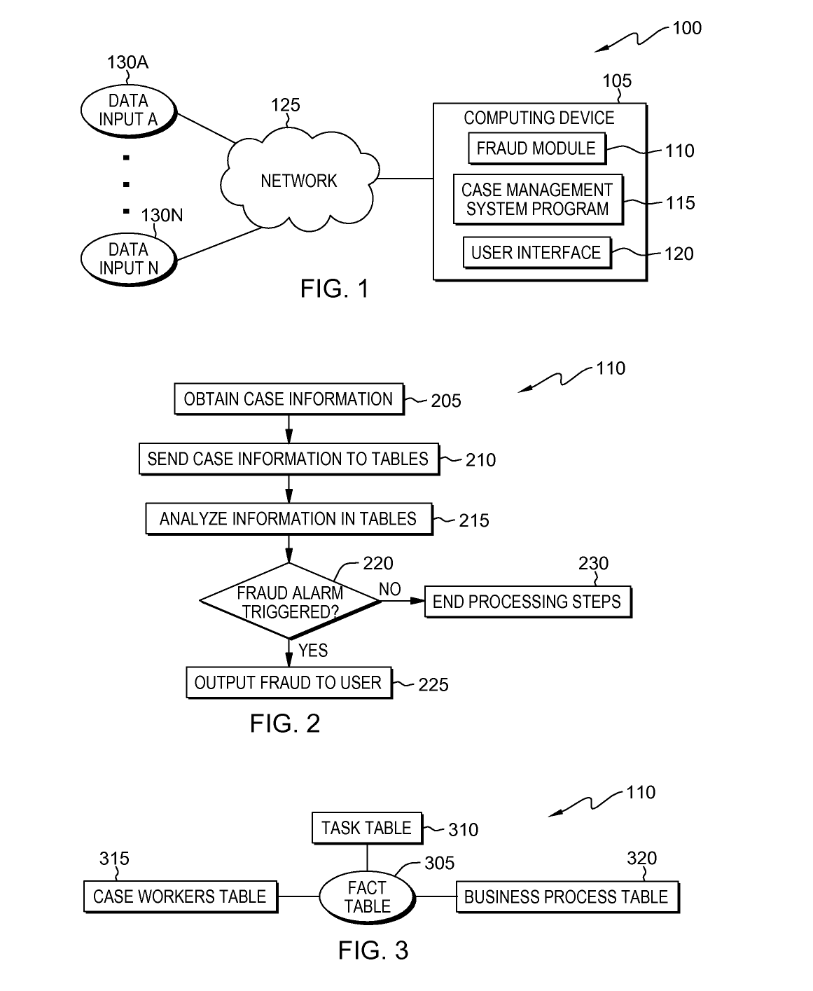

The present invention will now be described in detail with reference to the Figures. FIG. 1 is a functional block diagram illustrating a data processing environment, generally designated 100, in accordance with one embodiment of the present invention. FIG. 1 provides only an illustration of implementation and does not imply any limitations with regard to the environments in which different embodiments may be implemented. Modifications to data processing environment 100 may be made by those skilled in the art without departing from the scope of the invention as recited by the claims. In this exemplary embodiment, data processing environment 100 includes data input 130A-N and computing device 105 connected by network 125.

Data input 130A-N are sources of information which may be found in documents, data, video, audio and social media to be fed into case management system program 115 and/or fraud module 110. The sources of information, which are located within data input 130A-N, may be disparate or non-disparate in nature. In some embodiments, the information can be remotely accessed and updated via case updates residing in mobile and cloud-based case solutions. The “intelligent” analytics capability of case management system program 115 and/or fraud module 110 allows data input 130A-N to be encoded in a wide array of data formats. The case worker may decide which data input 130A-N sources need to be fed into case management system program 115 for further analysis.

Network 125 can be, for example, a local area network (LAN), a wide area network (WAN) such as the Internet, or a combination of the two, and can include wired, wireless, or fiber optic connections. In general, network 125 can be any combination of connections and protocols that will support communication between computing device 105 and data input 130A-N.

User interface 120 may be for example, a graphical user interface (GUI) or a web user interface (WUI) and can display text, documents, web browser windows, user options, application interfaces, and instructions for operation, and includes the information (such as graphics, text, and sound) a program presents to a user and the control sequences the user employs to control the program. User interface 120 is capable of receiving data, user commands, and data input modifications from a user and is capable of communicating with case management system program 115 and fraud module 110.

Case management system program 115 are solutions which enable decision makers (i.e., the case workers) to assemble, analyze, act on and archive content for improved business outcomes based on data input 130A-N. These solutions make it possible to gain value from the wealth of information in documents, data, video, audio and social media deriving from data input 130A-N. Case workers use case management system program 115 for a variety of applications such as answering customer requests, completing loan applications, or adjudicating a claim. Analytic tools of case management system program 115 are used to more efficiently and more accurately reach solutions based on data input 130A-N by searching documents, automating relevant processes, applying the appropriate analysis on data input 130A-N, and involving the appropriate people to create the most impactful workflow for an organization. Case management system program 115 has the capability to capture elements of a document via advanced document capture for rapid input and to convert documents into other data formats.

Fraud module 110 works in conjunction with case management system program 115 and user interface 120. Fraud module 110 retains necessary case information relevant to regulatory or legal requirements needed for a full audit trail. Fraud module 110 captures information and forms a knowledge base to be utilized for an internal fraud detecting system. This type of information includes: (i) a set of tasks executed by case workers to process a case; (ii) a sensitivity index for each task (to be defined at solution design time); (iii) the details of the case worker processing each task; and (iv) business process changes which occur in an organization. The corresponding case worker information executing each task is stored in relational database tables. The business process changes which occur in the organization are stored as a business process version. For each business process version, the cases are grouped according to the task set similarity. A threshold to check the similarity among business process versions is configured at system level. Upon analysis of this information, a determination is made as to whether a case has been processed in a usual or an unusual manner. A case processing is deemed as unusual if the tasks set similarity falls below the set threshold value, which may be indicative of an internal fraud. A similar approach can be used to identify the best suitable candidates for an audit. Instead of randomly choosing cases for audit, fraud module 110 systematically identifies a set of candidate cases on which a meaningful audit can take place.

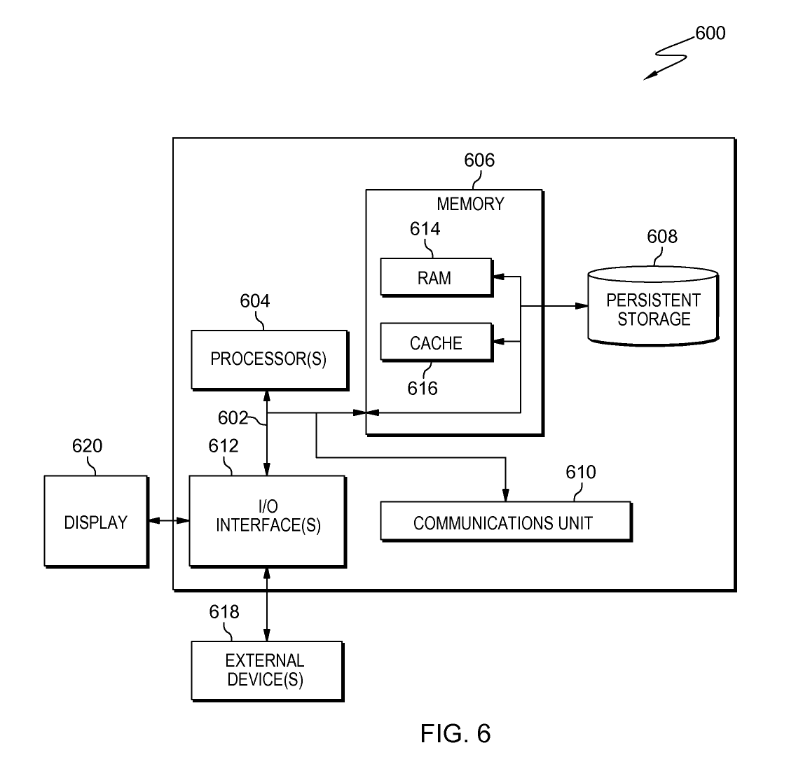

Computing device 105 includes fraud module 110, case management system program 115, and user interface 120. Computing device 105 may be a laptop computer, a tablet computer, a netbook computer, a personal computer (PC), a desktop computer, a personal digital assistant (PDA), a smart phone, a thin client, or any programmable electronic device capable of communicating with fraud module 110 and case management system program 115. Computing device 105 may include internal and external hardware components, as depicted and described in further detail with respect to FIG. 6.

FIG. 2 is a flowchart depicting the operational steps performed by fraud module 110 in order to form a knowledge base for an internal fraud detecting system, in accordance with an embodiment of the present invention.

In step 205, fraud module 110 obtains case information. For every case which is to be executed by case workers, a set of case information is obtained to form the knowledge base of internal fraud detecting system. The case information includes: (i) a task set (i.e., tasks required to process a case) to be executed by case workers to process a case (where the set of tasks which are executed during processing a case is captured); (ii) a sensitivity index for each task as defined in the system at a solution design time; (iii) details of case worker who process each task; and (iv) business process changes which occur within an organization.

In step 210, fraud module 110 sends case information to tables. The tables are relational tables to capture required data within defined categories including: (i) a task table; (ii) a case worker table; (iii) a business process table; and (iv) a fact table. The relational tables are described in further detail with respect to FIG. 3. Information associated with a case worker who executes each task is associated with a task set. The task set associated with the case worker who executes each task is stored within a relational task table. The changes that happen to a business process is versioned and stored in a business process table. For each business process version, cases are grouped based on the tasks set similarity. All the processed/completed cases are grouped together based on the business process versions within the business process table. Whenever a business process changes, a new business process entry is created in the knowledge base/fact table. The set of tasks that are executed as part of each case is captured along with the case workers information processing the case.

In step 215, fraud module 110 analyzes information in the (relational) tables. The obtained case information (from step 205) are grouped accordingly in the appropriate relational tables (from step 210). Fraud module 110 retrieves the information/data from the relational tables and compares the fact pattern of cases within the relational tables with an incoming case/table. For the new incoming case, depending on the set of tasks required to complete a case, a query is made to the knowledge base to get the number of cases from the repository of the relational tables which follow the same set of tasks as the incoming case. The actual threshold value is thus calculated for each business process version to determine the level of similarity of the incoming case to the number of cases found in the repository of the relationship tables.

In step 220, fraud module 110 determines if a fraud alarm is triggered. A threshold value is set at a system level to compare the level of similarity between an incoming case and the cases found in the repository of the relational tables. A reference threshold value is defined (e.g., 2% or 3% or 5%). Fraud module 110 allows for a certain percentage of differences between the incoming case and the cases found in the repository of the relational tables, before flagging the case for potential fraud activity. From the threshold value, a determination can be made as to whether a case has been processed in a usual or an unusual manner, based on the level of similarity between the incoming cases and the cases found in the repository of the relational tables. A determination of unusual processing and usual processing correspond with triggering a fraud alarm and not triggering a fraud alarm, respectively.

If in step 220, fraud module 110 determines a fraud alarm is triggered, then in step 225, fraud module 110 outputs the fraud to a user. A case is processed, and if the task set's level of similarity falls below the set threshold value, then the case is classified as unusual. This suggests an internal fraud has taken place and such a case is now a candidate for review (i.e., an audit) and a fraud alarm is triggered for the business process version associated with the case. The output to the user indicates that there is a potential fraud involving the case which has a level of similarity which falls below the set threshold value.

If in step 220, fraud module 110 determines a fraud alarm in not triggered, then in step 230, fraud module 110 ends the processing steps (of an incoming case). A case is processed, and if the task set level of similarity does not fall below the set threshold value, then the case is classified as usual. This suggests an internal fraud has not taken place and thus a fraud alarm is not triggered.

FIG. 3 is a functional block diagram illustrating a schema of a fraud module for storing relational tables, in accordance with an embodiment of the present invention.

Relational tables are used to capture the required data in order to form a knowledge base. Each of the relational tables has a primary key. A primary key, also called a primary keyword, is a key in a relational database that is unique for each record, which is a unique identifier, such as a driver license number, telephone number (including area code), or vehicle identification number (VIN). A relational database must always have one and only one primary key.

Fact table 305 performs one or more of the following functionalities: (i) utilizing a CaseID as the primary key for fact table 305; (ii) storing the identification of cases, the tasks set for each processed case, and the identification of the case worker who has processed the individual tasks of the task sets; (iii) utilizing TasksExecuted, which is a comma separated list of task identifications and constitutes the tasks set; (iv) utilizing CaseworkerID, which is a comma separated list of associated with the identification of case workers processing the tasks; and (v) utilizing ProcessID, which is a reference to the actual identification of a process from the business process table 320.

Task table 310 performs one or more of the following functionalities: (i) storing the identification of tasks and associated task names which are available for case workers to execute from; (ii) defining a sensitivity index of each task at a design time where the task sensitivity definition is based on the importance/impact of a task; (iii) defining a task with a high sensitivity index indicating the execution of the task is critical to the outcome of a case; (iv) defining a sensitivity using values in terms of numbers between 1 to 10 (where 10 is the most sensitive and 1 is the least sensitive); and (v) utilizing a task ID as the primary key for task table 310. For example, a case for a passport processing system having a “police verification” task of the applicant is defined as a highly sensitive task.

Case worker table 315 performs one or more of the following functionalities: (i) storing all of the existing identifications of case worker and the associated case worker names; and (ii) utilizing a case worker ID as the primary key for case worker table 315.

Business process table 320 performs one or more of the following functionalities: (i) storing the information associated business process changes which occur in a business/organization; (ii) utilizing a ProcessID as the primary key for business process table 320; (iii) utilizing columns titled “From” and “To” in order to input when the business process begins and ends, respectively, and in order to track the duration of each business process; (iv) utilizing a column titled “CanReUse” as a way of flagging potential fraud alarms; (v) processing a “CanReUse” column in terms of Boolean values; (vi) using Boolean values to store cases associated with a particular business process identification; (vii) querying the knowledge base to determine if a “tasks set” is below a set threshold; and (viii) upon determining there is no change to the business process, then ‘CanReuse’ flag indicates there is no potential fraud alarm.

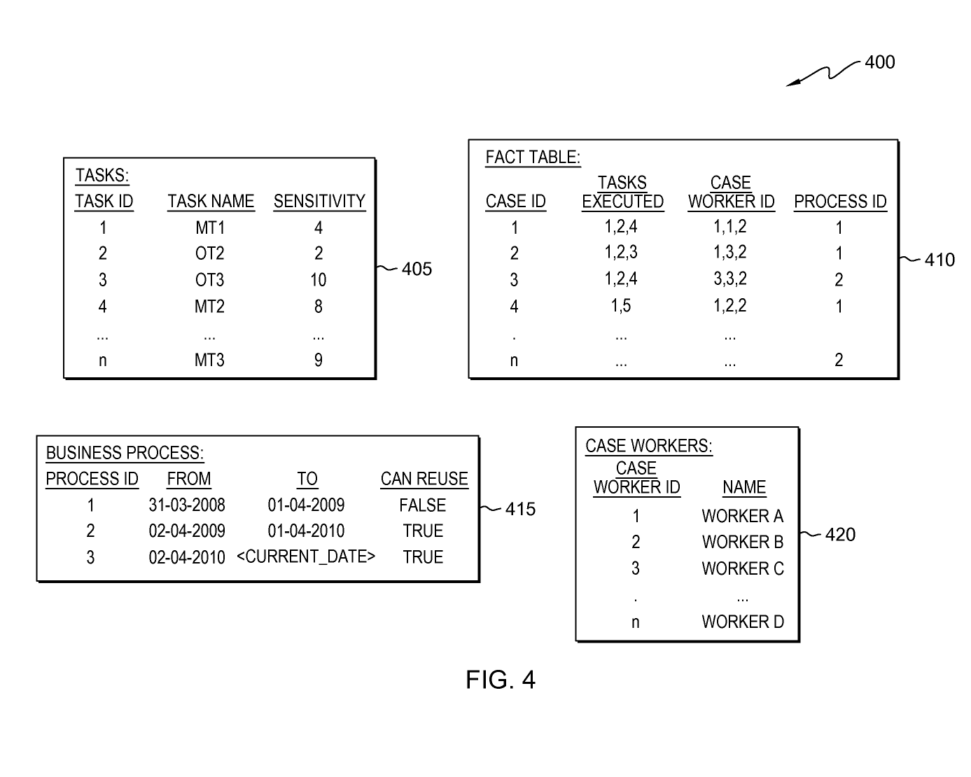

FIG. 4 is an example of configured relational tables 400, in accordance with an embodiment of the present invention.

Relational table 405 is an example of a task table (as shown in task table 310) configured by the identification of a task (under the “TaskID” column), the name of the task (under the “Task Name” column), and the sensitivity of a task (under the “Sensitivity” column).

Relational table 410 is an example of a fact table (as shown in fact table 305) configured by the identification of a case (under the “Case ID” column), the tasks executed within a task set of a case (under the “task executed” column), identifications of case workers associated with a case (under the “Case Worker ID” column), and the identification of the business process version (under the “Process ID” column).

Relational table 415 is an example of a business process table (as shown in business process table 320) configured by: the identification of the business process version (under the “Process ID” column), the beginning of a business process version (under the “From” column), the end of a business process version (under the “To” column), and whether a fraud has been triggered using Boolean values (under the “CanReUse” column).

Relational table 420 is an example of a case worker table (as show in case worker table 315) configured by: identifications of case workers (under the “Case Worker ID” column), and the name of the case worker associated with the identification of the case worker (under the “Name” column).

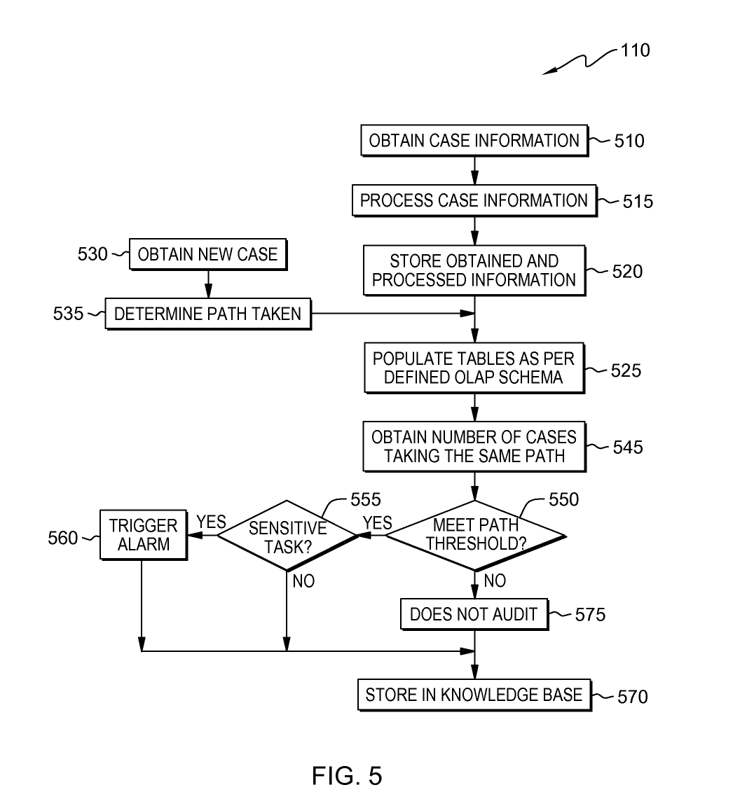

FIG. 5 is a flowchart detailing the operational steps of determining fraud via pathways by fraud module 110, in accordance with an embodiment of the present invention.

In step 510, fraud module 110 obtains case information. The obtained information includes the executed tasks associated with a case and the identification of the case workers executing the task associated with the case. The case information is already stored within a repository of relational tables.

In step 515, fraud module 110 processes the case information. Analytics performed on the executed tasks associated with the case generates the path taken by (i.e., the mode utilized to finish up a case) and the case workers to complete the executed tasks associated with the case. Analytics performed on the identification of the case workers generates a CaseworkerID (i.e., a comma separated list of the associated identification of case workers processing the tasks associated with the case).

In step 520, fraud module 110 stores the obtained and processed information (from steps 510 and 515, respectively). The obtained information which includes the executed tasks associated with a case and the identification of the case workers executing the task associated with the case are stored in task table 310 and case worker table 315, respectively. The resultant information is derived by the analytics performed on the executed tasks associated with the case to generate the path taken by the case workers to complete the tasks executed associated with the case. The resultant information derived by analytics performed on the identification of the case workers to generate a CaseworkerID are stored in task table 310 and case worker table 315, respectively.

In step 525, fraud module 110 populates tables as per defined OLAP schema. Online analytic processing (OLAP) is a multi-dimensional array of data to be analyzed in order to gain insights into the stored data/information. The OLAP schema is pre-defined. The processed information (from step 515) is stored into the corresponding tables for the OLAP schema proposed for fraud detection module. The information from case or cases from step 510 are used to populate the tables to be used later for fraud detection. Fraud module 110 may update the created OLAP as new cases are inputted into (see step 530) and processed by (see step 535). The OLAP schema compiles information such as the identification of case workers working on a case; the name of case workers; changes in business processes within an organization/business; task sets associated with a case; the pathway taken by a case worker to execute/complete task within a case; sensitivity index of a task; and the number of cases taking a particular pathway.

In step 530, fraud module 110 obtains a new case. For every new case which is to be executed by case workers, a set of new case information is obtained to form the knowledge base of an internal fraud detecting system. The new case information includes: (i) a task set (i.e., tasks required to process a case) to be executed by case workers to process a case (where the set of tasks which are executed during processing a case is captured); (ii) a sensitivity index for each task as defined in the system at a solution design time; (iii) details of case worker who process each task; and (iv) business process changes which occur within an organization.

In step 535, fraud module 110 determines the path taken (by a case worker to execute/complete a task in the newly obtained case from step 530). Analytics performed on the executed tasks associated with the new case generates the path taken by the case workers to complete the executed tasks associated with the newly obtained case. Analytics performed on the identification of the case workers generates a CaseworkerID (i.e., a comma separated list of the associated identification of case workers processing the tasks associated with the newly obtained case).

In step 545, fraud module 110 obtains the number of cases taking the same path (as other cases). From the OLAP schema, there is a compilation of cases which take the same path as other cases. From the OLAP schema, there is a compilation of cases which do not take the same path as other cases. A path threshold, X, is a ratio defined by eq. 1:

X=(Number of cases taking the same path)/(Total number of case)×100% (eq. 1).

The total number of cases is the number of cases which take the same path and the number of cases which do not take the same path as other cases. The likelihood of internal fraud being committed is quantified by X.

In step 550, fraud module 110 determine if a path threshold is met. A threshold value is configured to determine whether or not a possible fraud has occurred as described above. If X is valued to be above or equal to the configured threshold value, then fraud module 110 is concerned with the possibility of internal fraud. If X is value to be below the configured threshold value, then fraud module 110 is not concerned with the possibility of internal fraud.

If in step 550 fraud module 110 determines a path threshold is not met, then in step 575 fraud module 110 does not audit (a case or cases). The X value is below the configured threshold value and this suggests a fraud has not taken place.

If in step 550, fraud module 110 determines a path threshold is met, then in step 555 fraud module 110 determines if sensitive tasks (are involved). The X value is above or equal to the configured path threshold values and this suggests a fraud may have taken place as there are deviations in the path taken to execute the tasks within a case. The sensitivity of tasks are configured on a scale of 1 to 10 with 1 being the least sensitive and 10 being the most sensitive. Fraud module 110 examines the sensitivity of the tasks associated with a case.

If in step 555, fraud module 110 determines sensitive tasks (are involved), then in step 560 fraud module 110 triggers an alarm (for potential fraud). If sensitive tasks are executed during the processing of a case and is associated with a pathway used to execute the task within a case which deviates from a pathway “typically” used to execute the task within the case (i.e., the X value is above or equal to the configured threshold values). A case, which has been characterized as having sensitive tasks and having an X value above or equal to the configured threshold values, is now a candidate for an audit/review. Fraud module 110 identifies a probable occurrence of an internal fraud (i.e., frauds committed by internal employees processing using case management software); case workers (i.e., internal employees) who are committing a fraud; and a set of candidate cases most suitable for an organizational audit (i.e., borderline cases and atypical cases which need an audit). Thus, fraud module 110 conducts objective audits by providing a target list of cases based on a set of defined criteria.

If in step 555, fraud module 110 determines sensitive tasks are not involved, then in step 570 fraud module 110 stores additional information in the knowledge base. The additional information includes X values, whether a case meets the path threshold, whether a case executes at least one or more sensitive task, cases which trigger an alarm, and cases which are not audited.

FIG. 6 depicts a block diagram of components of a computing device, generally designated 600, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computing device 600 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer readable storage media. In this embodiment, memory 606 includes random access memory (RAM) 614 and cache memory 616. In general, memory 606 can include any suitable volatile or non-volatile computer readable storage media.

Program instructions and data used to practice embodiments of the present invention may be stored in persistent storage 608 for execution and/or access by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Program instructions and data used to practice embodiments of the present invention may be downloaded to persistent storage 608 through communications unit 610.

I/O interface(s) 612 allows for input and output of data with other devices that may be connected to computing device 600. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention, e.g., software and data, can be stored on such portable computer readable storage media and can be loaded onto persistent storage 608 via I/O interface(s) 612. I/O interface(s) 612 also connect to a display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising:
identifying, by one or more processors, respective paths executed by each case in a plurality of cases, wherein each case includes respective case information;
responsive to receiving a new case, creating, by one or more processors, an OLAP schema that specifies respective paths associated with the new case; and
determining, by one or more processors, whether the new case is a candidate for audit based on a measure of deviation between the respective paths associated with the new case and the respective paths of each case within the plurality of cases.

2. The method of claim 1, wherein determining whether the new case is a candidate for audit based on the measure of deviation between the respective paths associated with the new case and the respective paths of each case within the plurality of cases, comprises:
comparing, by one or more processors, case information associated with the new case to case information associated with each case in the plurality of cases; and
configuring, by one or more processors, a threshold, wherein the threshold is a value used to compare a similarity level between the plurality of cases and the new case.

3. The method of claim 1, wherein the knowledge base provides case information for each completed case.

4. The method of claim 1, wherein creating the OLAP schema, comprises:
identifying, by one or more processors, a plurality of tasks, a respective sensitivity index, case worker information, and business processes associated with the new case;
populating, by one or more processors, relational tables for the plurality of tasks, the respective sensitivity index, case worker information, and business processes associated with the new case; and
grouping, by one or more processors, the plurality of tasks into subsets of tasks based on a similarity between the tasks, case worker information, and business processes associated with the new case.

5. The method of claim 1, wherein the measure of deviation is based on a set of tasks performed for the new case and another set of tasks associated with the plurality of cases.

6. The method of claim 4, further comprising:
responsive to receiving a business process change, modifying, by one or more processors, the OLAP schema based on identified paths specified by the business process change.

7. The method of claim 2, further comprising:
responsive to determining the configured threshold value does not exceed the predetermined similarity level to the plurality of the stored cases, generating, by one or more processors, an indication that the new case is potentially fraudulent;
determining, by one or more processors, whether tasks associated with the new case are associated with a high sensitivity index; and
responsive to determining at least one tasks of the tasks associated with a high sensitivity index are associated with the new case, triggering, by one or more processors, a fraud alarm for the new case and alerting users associated with the new case.

8. A computer program product comprising:
a computer readable storage device program instructions stored on the computer readable storage device, the program instructions comprising:
program instructions to identify respective paths executed by each case in a plurality of cases, wherein each case includes respective case information;
responsive to receiving a new case, program instructions to create an OLAP schema that specifies respective paths associated with the new case; and
program instructions to determine whether the new case is a candidate for audit based on a measure of deviation between the respective paths associated with the new case and the respective paths of each case within the plurality of cases.

9. The computer program product of claim 8, wherein the program instructions to determine whether the new case is a candidate for audit based on the measure of deviation between the respective paths associated with the new case and the respective paths of each case within the plurality of stored cases, comprise:
program instructions to compare case information associated with the new case to case information associated with each case within the plurality of cases; and
program instructions to configure a threshold, wherein the threshold is a value used to compare a similarity level between the plurality of stored cases and the new case.

10. The computer program product of claim 8, wherein the knowledge base provides case information for each completed case.

11. The computer program product of claim 8, program instructions to create the OLAP schema, comprise:
program instructions to identify a plurality of tasks, a respective sensitivity index, case worker information, and business processes associated with the new case;
program instructions to populate relational tables for the plurality of tasks, the respective sensitivity index, case worker information, and business processes associated with the new case; and
program instructions to group the plurality of tasks into subsets of tasks based on a similarity between the tasks, case worker information, and business processes associated with the new case.

12. The computer program product of claim 8, wherein the measure of deviation is based on a set of tasks performed for the new case and another set of tasks associated with the plurality of the cases.

13. The computer program product of claim 11, further comprising:
responsive to receiving a business process change, program instructions to modify the OLAP schema based on identified paths specified by the business process change.

14. The computer program product of claim 9, further comprising:
responsive to determining the configured threshold value does not exceed the predetermined similarity level to the plurality of cases, program instructions to generate an indication that the new case is potentially fraudulent;
program instructions to determine whether tasks associated with the new case are associated with a high sensitivity index; and
responsive to determining at least one tasks of the tasks associated with a high sensitivity index are associated with the new case, program instructions to trigger a fraud alarm for the new case and alerting users associated with the new case.

15. A computer system comprising:
one or more computer processors;
one or more computer readable storage device; and
program instructions stored on the one or more computer readable storage device for execution by at least one of the one or more processors, the program instructions comprising:
program instructions to identify respective paths executed by each case in a plurality of cases, wherein each case includes respective case information;
responsive to receiving a new case, program instructions to create an OLAP schema that specifies respective paths associated with the new case; and
program instructions to determine whether the new case is a candidate for audit based on a measure of deviation between the respective paths associated with the new case and the respective paths of each case within the plurality of cases.

16. The computer system of claim 15 wherein the program instructions to determine whether the new case is a candidate for audit based on a measure of deviation between the respective paths associated with the new case and the respective paths of each case within the plurality of cases, comprise:
program instructions to compare case information associated with the case to case information associated with each case within the plurality of cases; and
program instructions to configure a threshold, wherein the threshold is a value used to compare a similarity level between the plurality of cases and the new case.

17. The computer system of claim 15, wherein the knowledge base provides case information for each completed case.

18. The computer system of claim 15, program instructions to create the OLAP schema, comprise:
program instructions to identify a plurality of tasks, a respective sensitivity index, case worker information, and business processes associated with the new case;
program instructions to populate relational tables for the plurality of tasks, the respective sensitivity index, case worker information, and business processes associated with the new case; and
program instructions to group the plurality of tasks into subsets of tasks based on a similarity between the tasks, case worker information, and business processes associated with the new case.

19. The computer system of claim 15, wherein the measure of deviation is based on a set of tasks performed for the new case and another set of tasks associated with the plurality of cases.

20. The computer system of claim 16, further comprising:
responsive to determining the configured threshold value does not exceed the predetermined similarity level to the plurality of cases, program instructions to generate an indication that the new case is potentially fraudulent;
program instructions to determine whether tasks associated with the new case are associated with a high sensitivity index; and
responsive to determining at least one tasks of the tasks associated with a high sensitivity index are associated with the new case, program instructions to trigger a fraud alarm for the new case and alerting users associated with the new case.
